(19) United States
(12) Patent Application Publication
(10) Pub. No.: US 2004/0191751 A1
(43) Pub. Date: Sep. 30, 2004

(54) Method of and apparatus for providing information on product, and computer program

(75) Inventors: Kosei Takano, Tokyo (JP); Daiji Yamano, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/792,767

(22) Filed: Mar. 5, 2004

(30) Foreign Application Priority Data
Mar. 27, 2003 (JP) 2003-089220

(51) Int. Cl. G09B 7/00; G09B 5/00

(52) U.S. Cl. 434/362

(57) ABSTRACT

An apparatus provides, via a network, a customer device of a customer with information on risks associated with a risky product. The apparatus includes an education giving unit that gives an education related to the risks associated with the risky product to the customer through the customer device and an education history storing unit that stores a progress of the education given to the customer as a history of the education given.

### BACKGROUND OF THE INVENTION

1) Field of the Invention

The present invention relates to a technology for providing, via a network, a customer device of a customer with information on risks associated with risky products.

2) Description of the Related Art

In general, risks of value fluctuation with time are associated with financial products such as stocks and bonds sold by financial institutions. A conventional technology related to selling agreement of such risky products has been disclosed in Japanese Patent Application Laid-open Publication No. 2002-63371. The conventional technology discloses to send to a client, upon receiving a request from the client, image information that explains the contents of the financial product and the potential risks associated with it. The potential risks include, for example, possible interest rate fluctuation and possible loss of principal amount invested.

It is necessary for a person who has such risky products or who is planning to purchase the risky products to keep track of the latest information that may cause fluctuations in the risks associated with the risky products. The changes in the social conditions or status of the companies, amendments in the laws, for example, cause the fluctuations in the risks associated with the risky products. Besides, depending on the lifestyle of a person it may sometime become necessary for him/her to sell the risky products he/she has or newly purchase risky products.

Because the factors that cause the fluctuations in the risks associated with the risky products are numerous and complicated, it is very difficult for an ordinary person to make a decision on when, how many, and which risky products to purchase or sell, how much to sell holdings, and when is a good time for adding to the holdings.

The conventional technology does not provide ordinary people with all the information that will help them make the decision. Because of the lack of the information, people have a tendency to go for safer products such as time deposits rather than to go for the risky products.

If the people are given appropriate information they will be able to estimate the risks associated with the risky products more accurately and may even go for the risky products.

### SUMMARY OF THE INVENTION

The object of the present invention is to provide a means and a method that allows providing, via a network, a customer with information on the risks associated with the risky products.

An apparatus according to an aspect of the present invention provides, via a network, a customer device of a customer with information on risks associated with a risky product. The apparatus includes an education giving unit that gives an education related to the risks to the customer through the customer device; and an education history storing unit that stores a progress of the education as a history of the education given.

A method according to another aspect of the present invention provides, via a network, a customer device of a customer with information on risks associated with a risky product. The method includes giving an education related to the risks to the customer through the customer device; and storing a progress of the education as a history of the education given.

A computer program according to still another aspect of the present invention realizes the method according to the above aspect on a computer.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a schematic of an education system according to an embodiment of the present invention;

FIG. 2 is a block diagram of an education server in the education system;

FIG. 3 is an example of contents of a customer DB;

FIG. 4 is an example of contents of an in-hand-product DB;

FIG. 5 is an example of contents of an education contents DB;

FIG. 6 is an example of contents of an event-to-education DB;

FIG. 7 is an example of contents of an event-to-product DB;

FIG. 8 is an example of contents of a lesson history DB;

FIG. 9 is a flowchart of a process procedure for customers and lessons selection;

FIG. 10 is a flowchart of a process procedure for executing education;

FIG. 11 is a schematic of a computer system according to another embodiment of the present invention; and

FIG. 12 is a block diagram of a main unit of the computer system.

### DETAILED DESCRIPTION

Exemplary embodiments of an apparatus, a method, and a computer program that realizes the method on a computer, according to the present invention are explained in detail below with reference to the accompanying drawings. A system for giving an education to a customer (hereinafter, “education system”) is explained below as an embodiment of the present invention although the present invention is not limited to the education system.

In the following explanation, the term “product” or “risky product” refers to a product in which there is a risk that the value of the product may change as the time passes. Such risky products include stocks and bonds that are sold by the financial institutions.

The term “education” refers to lessons given or taken through the Internet (e-learning) about the risks associated with the risky products. Lessons on “Securities Exchange Act” or “Types and mechanism of investment trust” are examples of such education.

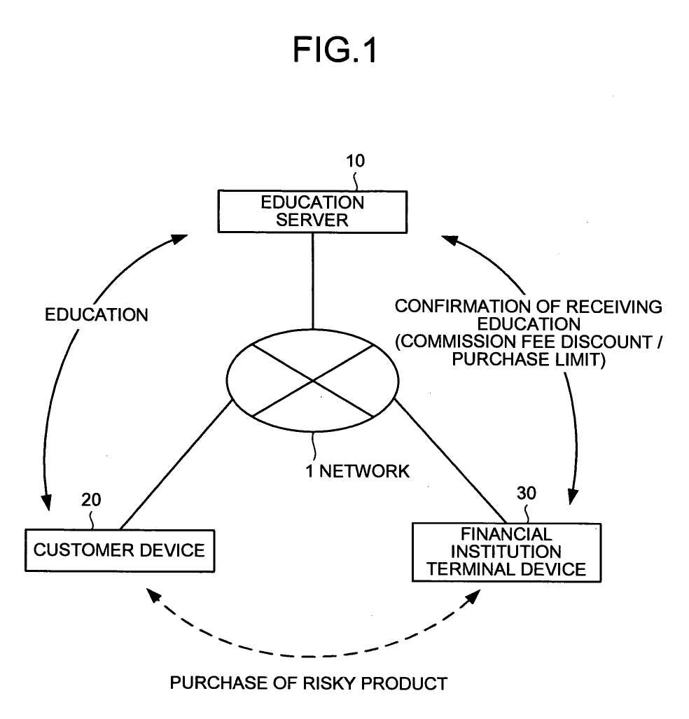

FIG. 1 is a schematic of an education system according to an embodiment of the present invention. The education system includes an education server 10 of an educational institution, a customer device 20 of a customer, and a financial institution terminal device 30 of a financial institution. The education server 10, the customer device 20, and the financial institution terminal device 30 communicate with each other via a network 1 (e.g., the Internet).

The education server 10 and the financial institution terminal device 30 are linked up together to provide the customer device 20 with various information on the risky products. The customer device 20 can be a personal computer (PC), a workstation, a home game machine, an Internet TV, or a mobile communication terminal such as a personal digital assistance (PDA), a cellular telephone, and a personal handyphone system (PHS) terminal.

The education system gives education to the customers via the customer devices 20 so that the customers get enough information about the risks associated with the risky products. As a result of such education, the customers can accurately estimate the risks associated with the risky products.

If the education is given to the customers about the risks associated with the risky products they have purchased, because the customers have sufficient knowledge about the risks associated, they can decide accurately whether to continue to possess those risky products or sell them. As a result, an obstacle that is hindering the entry of the customers who are deliberating to switch from an investment in the safer products to the risky products is cleared. Consequently, this shall enable sound expansion and growth of market of the risky products.

The education server 10 picks up customers who have specific life events such as wedding and childbirth, and gives them the education accordingly. Thus, the customers can receive the education at an appropriate timing of the occurrence of the life events. As a result, the customers can promptly and accurately estimate fluctuations in the risks due to the life events.

The education server 10 also picks up members who are affected by social events such as an announcement of company's business performance and abnormal weather, and gives them the education accordingly. Thus, the customers can receive the education at an appropriate timing of the occurrence of the social events. As a result, the customers can promptly and accurately estimate fluctuations in the risks due to such social events.

The education server 10 does not give the customer the education if the customer took the education in the past. When giving the education to the customer, the education server 10 gives emphasis on specific lessons based on the lesson history of the customer. This scheme allows an appropriate education to be given to the customers as well as effectively facilitates their understanding about the risks associated with the risky products.

Upon completion of the education of a customer, the education server 10 conducts a test for the customer to objectively evaluate to what extent the customer has understood the contents of the education. The result of the test (hereinafter, “test result”) may be in the form of marks, grades, or levels. Because most people like to acquire good test results, this scheme stimulates customers' motivation for taking the education as well as effectively facilitates their understanding about the risks associated with the risky products.

The education server 10 stores a record, including the test result, of education taken by each customer. Upon receiving a query from the financial institution terminal device 30 on whether a customer has taken the education of interest in the past, the education server 10 checks the record of the customer and responds to the financial institution terminal device 30 accordingly. If the record shows that the customer took the education in the past, the education server 10 calculates an amount of discount based on the test result of the customer, and informs it to the financial institution terminal device 30. The financial institution then gives a discount to the customer on the purchase commission fees or administration commission fees. Because most people like to get discounts, this scheme stimulates customers' motivation for taking the education and acquiring better test result as well as effectively facilitates their understanding about the risks associated with the risky products.

Based on the record of a customer including lessons he/she took in the past and the test result, the education server 10 suggests risky products that are suitable for that customer. For example, certain risky products are sold only to those customers who achieved a certain level from the test. In other words, such risky products are sold only to those customers who have acquired sufficient knowledge about those risky products. This scheme makes it possible to prevent selling of the risky products to those who have an insufficient understanding of the risks.

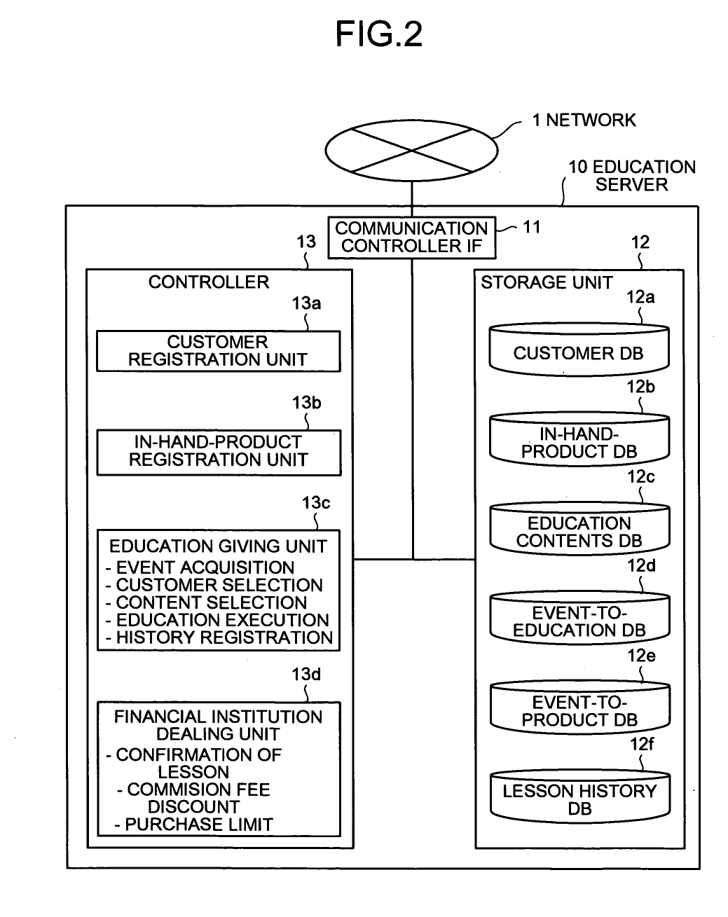

FIG. 2 is a block diagram of the education server 10. The education server 10 includes a communication controller interface (I/F) 11, a storage unit 12, and a controller 13. The communication controller I/F 11 controls communications between the customer device 20 and the financial institution terminal device 30 via the network 1.

The storage unit 12 stores computer programs and data. The data is, for example, web data to be displayed on a screen of a monitor of the customer device 20. The storage unit 12 includes a customer DB (database) 12a, a in-hand-product DB 12b, an education contents DB 12c, an event-to-education DB 12d, an event-to-product DB 12e, and a lesson history DB 12f.

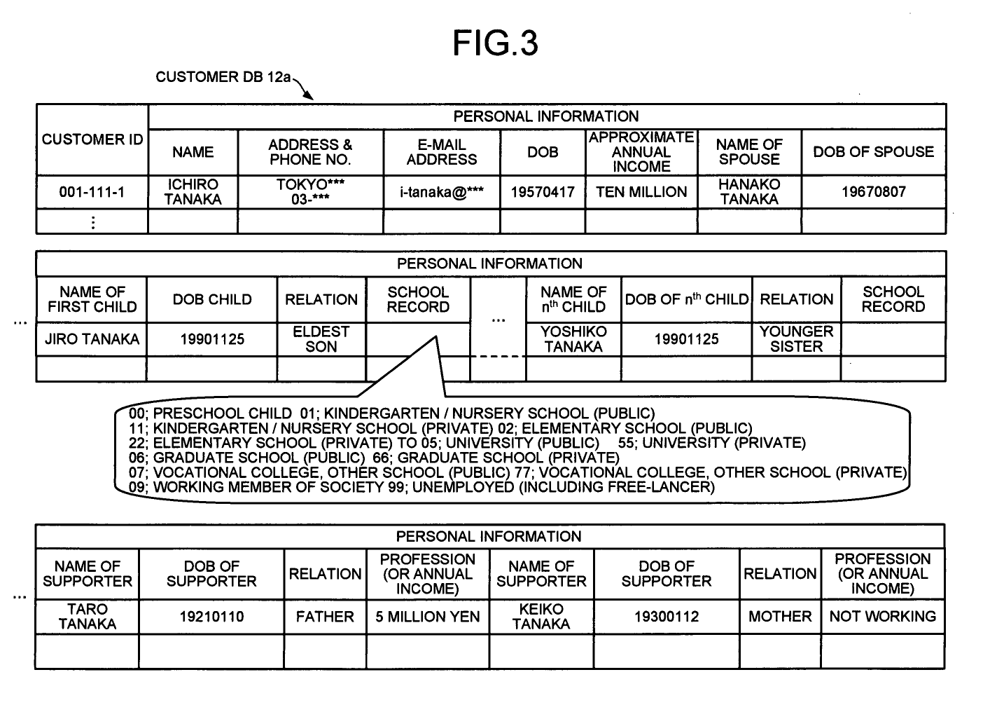

The customer DB 12a stores personal information of the customers. As shown in FIG. 3, the personal information includes name, address and phone number, e-mail address, date of birth (DOB), approximate annual income, name and DOB of the spouse, names and DOBs of children, relation with the customer, school information of the children, name and DOB of supporter, relation with the customer, profession (or annual income) of the supporter etc. associated with customer ID of each customer.

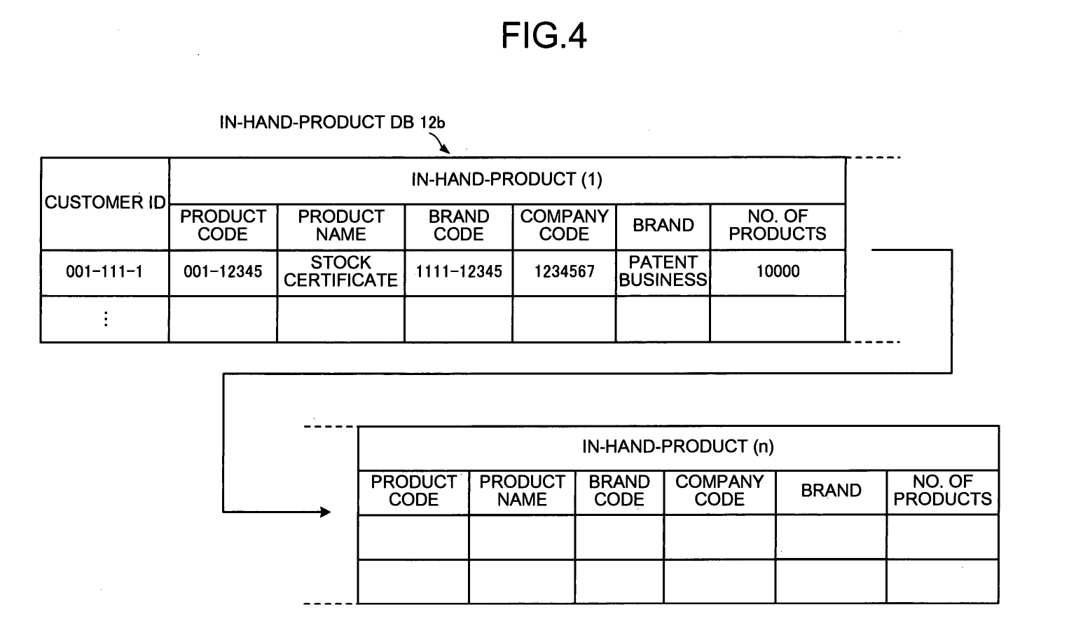

The in-hand-product DB 12b stores information on risky products possessed by the customers. As shown in FIG. 4, the information includes, product code, product name, brand code, company code, brand, and number of each risky product possessed by the customer associated with each customer ID.

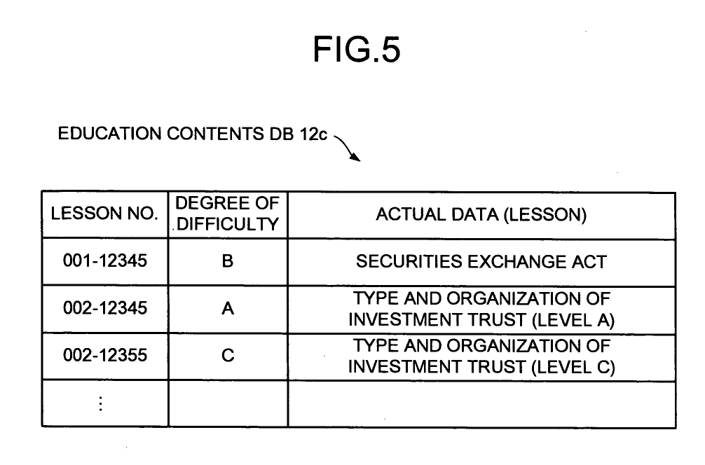

The education contents DB 12c stores contents of the education offered by the education server 10. As shown in FIG. 5, such contents include degree of difficulty, details of actual data (lesson) associated with each lesson number. The actual data includes email data and/or web data that are to be displayed on the screen of the monitor of the customer device 20 of the customer when giving the education to him/her.

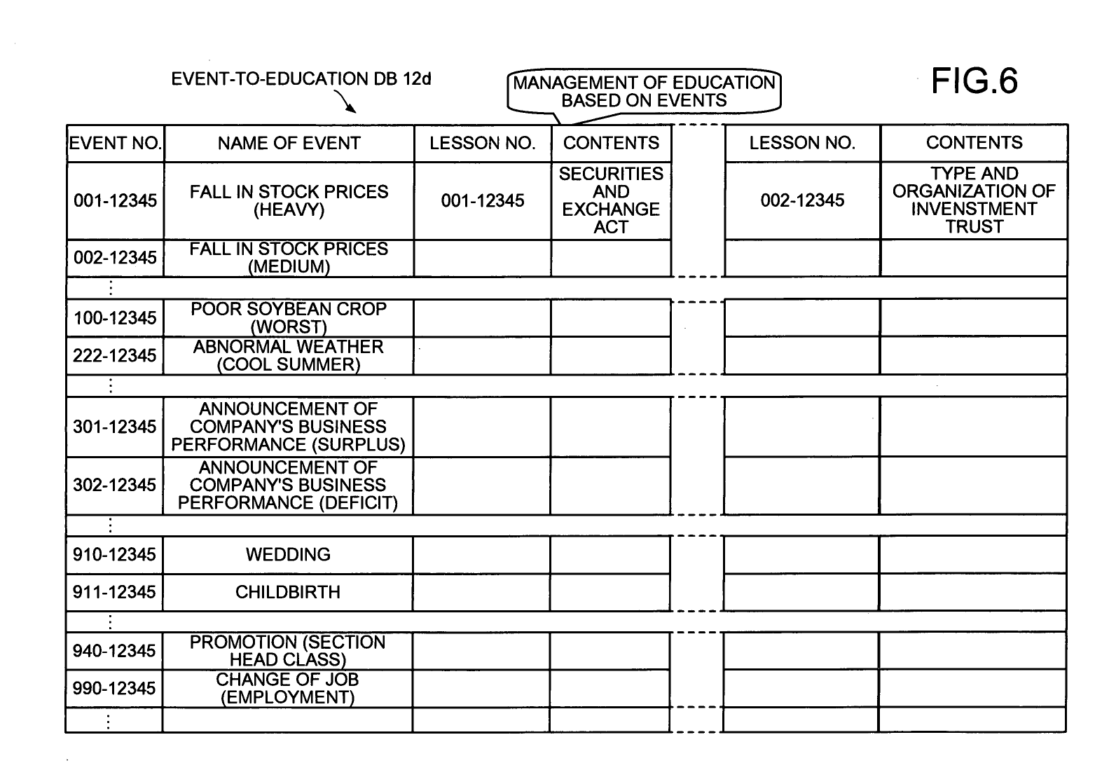

The event-to-education DB 12d stores a correspondence of events to education. As shown in FIG. 6, such correspondence includes name of event, lesson numbers, contents of lesson associated with each event number. In other words, the event-to-education DB 12d stores lessons and specific social or life events in correlated manner. The social event or the life events include, for example, fall in stock price, good or poor soybean crop, wedding, childbirth, announcement of company's business performance, promotion, change of job.

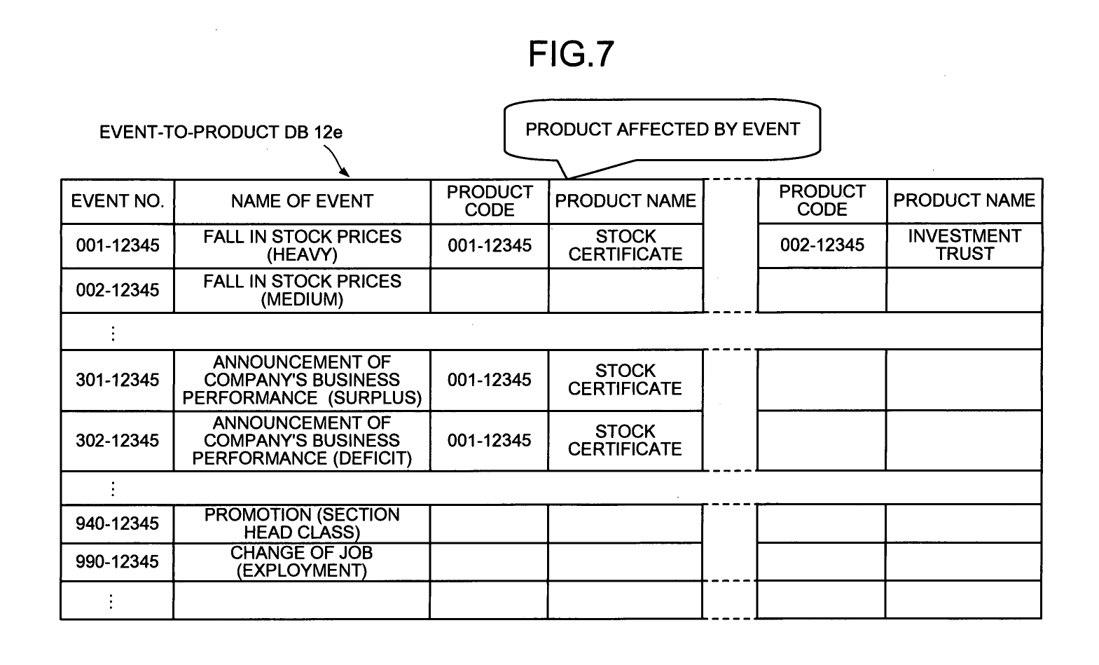

The event-to-product DB 12e stores correspondence of events to risky products. As shown in FIG. 7, such correspondence includes name of even, product codes, and product names associated with each event number.

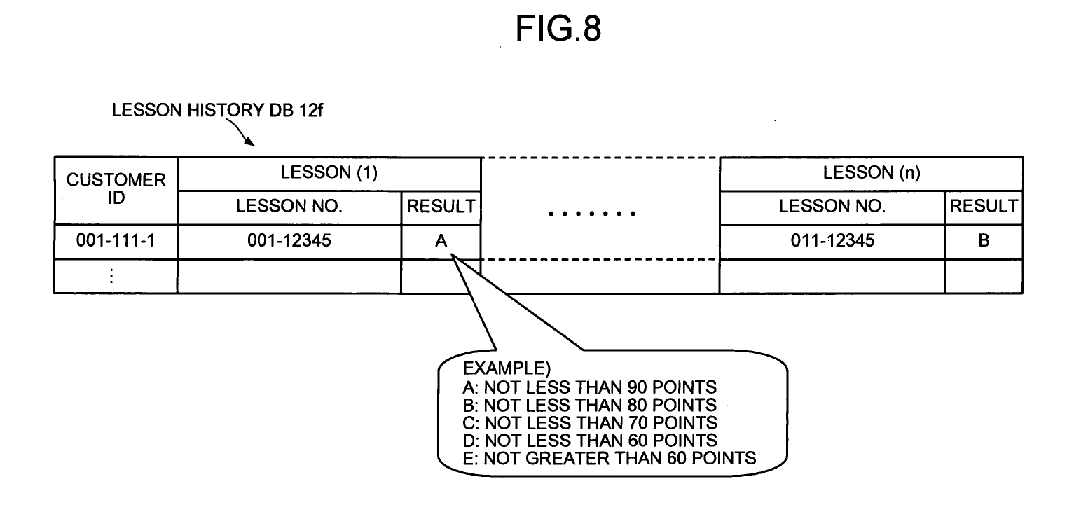

The lesson history DB 12f stores a history of the lessons taken in the past by the customers and the history of the lessons offered to the customers. As shown in FIG. 8, such history includes lesson numbers, and test result associated with each customer ID.

The controller 13 has an internal memory (not shown). The internal memory stores a control program such as an operating system (OS), computer programs for performing predetermined processing procedures, and data required to execute the control program. The controller 13 executes various processes by running the computer programs stored in the internal memory. The controller 13 also includes, as shown in FIG. 2, a customer registration unit 13a, an in-hand-product registration unit 13b, an education giving unit 13c, and a financial institution dealing unit 13d.

The customer registration unit 13a receives from the customers, via the customer devices 20, their personal information and registers it in the customer DB 12a. The personal information can be registered when a customer enrolls for the first-time or when there is a change in the personal information of a registered customer due to a life event such as a wedding.

The in-hand-product registration unit 13b receives from the customers, via the customer devices 20, information on the risky products possessed by them and registers it in the in-hand-product DB 12b. The information can be registered when a customer enrolls for the first time, purchases a risky product after registering, or when there is a change in the personal information of the customer due to a trading of an in-hand-product.

The education giving unit 13c monitors if a social event or a life event has occurred and selects the customers who are affected by the event. The education giving unit 13c then selects lessons to be offered to such customers, gives appropriate education to them, conducts a test to check how much they have understood, and registers which lessons have been given to such customers and their test results in the lesson history DB 12f.

The education giving unit 13c selects customers possessing risky products that are affected by the event. Concretely, when there is a life event such as a promotion or a change of job (employment), or a social event such as a fall in stock prices or an announcement of company's business performance, the education giving unit 13c refers to the event-to-product DB 12e and retrieves product names associated with the event number of the event. As a result, the risky products that are affected by the event are identified. Subsequently, the education giving unit 13c refers to the in-hand-product DB 12b and retrieves the customer IDs associated with the product names retrieved from the event-tb-product DB 12e. As a result, the customers (hereinafter, “event-affected-customers”) who possess the risky products that are affected by the event are identified.

The education giving unit 13c then refers to the event-to-education DB 12d and retrieves the lessons associated with the name of the event. As a result, lessons (hereinafter, “event-related-lessons”) that give a knowledge about fluctuation in the risks associated with the risky product by the event are identified.

The education giving unit 13c then offers the event-related-lessons to the event-affected-customers. When offering the lessons, the education giving unit 13c refers to the lesson history DB 12f to check if a customer from among the event-affected-customers has already taken a lesson from among the event-related-lessons. If the customer took the lesson in the past, the education giving unit 13c does not offer that lesson to the customer. Alternatively, although the customer took the lesson in the past, but if the test result of that lesson of the customer is below certain level, the education giving unit 13c offers the corresponding lesson to the customer, and adjusts the speed of curriculum of the lesson according to the lesson history. This scheme makes it possible to give appropriate education that matches with needs and capabilities of the customers.

The education giving unit 13c sends information to the customer devices 20 of the customers to take a test to check to what extent they have understood the lessons. The education giving unit 13c registers the test results as history of each customer in the lesson history DB 12f. Because most people like to acquire good test results, this scheme stimulates customers' motivation for taking the education and studying harder.

The financial institution dealing unit 13d functions in association with the financial institution terminal devices 30 of the financial institutions. These functions include, for example, responding to queries from the financial institution terminal device 30 and exchanging data about the customers or the risky products with the financial institution terminal device 30. The functions are explained in detail below.

Upon receiving a request from the financial institution terminal device 30 to confirm whether a customer has taken the education offered by the education server 10, the financial institution dealing unit 13d refers to the lesson history DB 12f and checks whether the customer has taken the education in the past. If the customer has taken the education in the past, the financial institution dealing unit 13d retrieves the test result associated with the lesson, calculates a discount amount to be offered to the customer based on the test result and informs it to the financial institution terminal device 30. The financial institution gives the customer a discount for the purchase commission fee or the administration commission fee of the risky product. Because most people like to get discounts, this scheme stimulates customers' motivation for taking the education and acquiring better test result as well as effectively facilitates their understanding about the risks associated with the risky products.

On the other hand, if the customer has not taken the education before, or if the customer has taken the education before but the test result associated with the lesson is below a certain level, the financial institution dealing unit 13d informs this fact to the financial institution terminal device 30. In this case, the financial institution puts some kind of limitation on the purchase of the risky products by the customer. For example, if the customer has not taken the education before, it means that the customer has an insufficient knowledge of the risks associated with the risky products to go into a trading of such products; therefore, the financial institution does not sell the risky products to the customer. This scheme prevents the customers who do not have a sufficient knowledge about the risks associated with the risky products from purchasing or selling of the risky products.

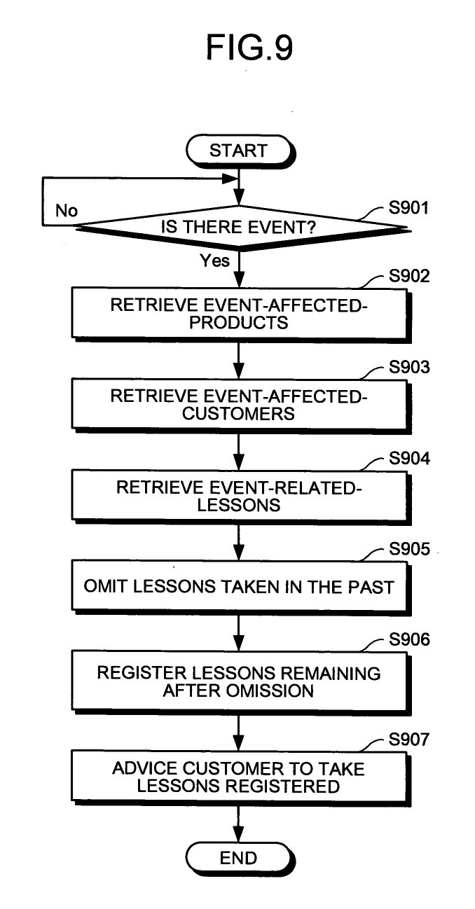

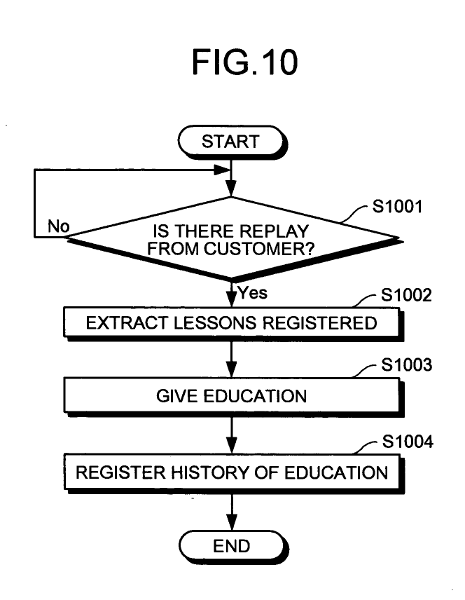

The process procedure performed by the education server 10 is described in FIGS. 9 and 10. The process procedure is divided into 1) a process procedure for selecting customers and lessons (hereinafter, “customers and lessons selection”) and 2) a process procedure for giving education (hereinafter, “education execution”).

FIG. 9 is a flowchart of the customers and lessons selection. The education giving unit 13c of the education server 10 monitors if a social event or a life event has occurred (step S901).

If the event has occurred (“Yes” at step S901), the education giving unit 13c retrieves from the event-to-product DB 12e the product names associated with the event number of the event (step S902). As a result, the risky products (hereinafter, “event-affected-products”) that are affected by the event are retrieved.

The education giving unit 13c then refers to the in-hand-product DB 12b and retrieves the customer IDs associated with the event-affected-products (step S903). As a result, the event-affected-customers are retrieved.

The education giving unit 13c then refers to the event-to-education DB 12d and retrieves the lesson associated with the name of the event (step S904). As a result, the event-related-lessons are retrieved.

The education giving unit 13c then refers to the lesson history DB 12f to check if a customer from among the event-affected-customers has. already taken a lesson from among event-related-lessons. If the customer took the lesson in the past, the education giving unit 13c does not offer that lesson to the customer (step S905).

The education giving unit 13c then registers the lessons remaining in the event-related-lessons as the lessons to be offered to the event-affected-customers corresponding to each event-affected-customer (step S906).

The education giving unit 13c then sends an email message to the customer devices 20 to advice the event-affected-customers to take the lessons remaining in the event-related-lessons (step S907).

FIG. 10 is a flowchart of the education execution. The education giving unit 13c checks if there is a reply from a customer to the email message sent to him at step S907 (step S1001).

When there is a reply from the customer (“Yes” at step S1001), the education giving unit 13c retrieves the lessons registered in the lesson history DB 12f at step S906 (step S1002).

The education giving unit 13c gives education to the customer based on the lessons retrieved at step S1002 (step S1003). When giving the education, the education giving unit 13c retrieves the actual data associated with the lesson number from the education contents DB 12c and sends it to the customer device 20 for displaying on the screen of the monitor. Upon completion of the education of the customer, the education giving unit 13c conducts a test for the customer to objectively evaluate to what extent the customer has understood the contents of the education.

Finally, the education giving unit 13c registers in the lesson history DB 12f the lessons taken by the customer and the test result, as the history of the education taken by customer, and issues an education receiver ID to the customer and registers the education receiver ID in the lesson history DB 12f (step S1004). The history of the education is referred to when there is a query from the financial institution terminal device 30.

How a customer can effectively make use of the education system will now be explained from a view point of the customer. Mr. X, upon deliberating on low interest on deposits nowadays, was thinking of purchasing financial products that would yield him high returns. However, Mr. X had never purchased financial products other than the time deposits and was hesitant to purchase stocks or bonds.

Mr. Y, a colleague of Mr. X, told Mr. X of an educational website that provides the customers with the education related to changes in the financial situations according to the financial product possessed by the customers. In other words, whenever there is a change in the financial situation, the educational site automatically informs to the appropriate customers a URL of educational contents related to the change. Mr. Y further added that taking lessons from the educational site enables to make an accurate judgment of what and how much risks are associated with the financial products and that he has become a member of the education site and has been investing in stocks.

Therefore, Mr. X also decided to register himself as a member of life event and social event educational site (the education server of the present invention). Mr. X purchased stocks of a certain company and registered personal information after making an access to the education site. Mr. X came across a report in the month of October of that year on final accounts for the first half of the year of the company of which he had purchased the stocks. Mr. X was informed by email message that he would be able to take lessons about settlement of accounts and about a trend of stocks at that particular time. The email message included an URL.

Mr. X immediately accessed the URL mentioned in the email message and took education accordingly. The education was given to him based on a specific curriculum and displaying text and/or images on his computer. Mr. X completed one lesson and took a test. In the test, the questions and a plurality of prospective answers were displayed on the computer screen and he had to select a proper answer for each question. Once the test was over, the test result was displayed. Mr. X got 60 points, but minimum points required for passing were 70. Therefore, Mr. X studied harder the topics related to the questions he made wrong answers and took the test again. This time he got 85 points. In the similar manner, Mr. X took other lessons and completed the education. Once the education was completed an education receiver ID was issued to Mr. X.

As a result of acquiring proper knowledge by the education, Mr. X made a judgment that it is beneficial for him to purchase few more stocks of the corresponding company. Mr. X cancelled his time deposit and purchased few more stocks. After certain period, the stock price of the company went up and Mr. X made profits much higher than the interest he could have got on the time deposit.

Mr. X was expecting a child by the beginning of the next year. So Mr. X registered his child's birth schedule with the educational site. While Mr. X was trying hard to work out the expenses for the childbirth, Mr. X was informed via an email message just a few days before the child was expected to be born that he can receive education or recent trends in the stocks (although it is not a time for settlement of accounts, Mr. X can get information about fluctuations in the stock prices according to a trend of business condition and a long-term weather forecast). Mr. X took the education.

Mr. X was in need of money for the childbirth. As a result of acquiring proper knowledge by the education, Mr. X estimated, based on the long-term weather forecast, the current trends in the market, and the fact that the price of his stocks are currently going up, that the rate of rise in prices of his stokes is higher than the interest on the loan, and decided to borrow money as a short term loan from the bank instead of selling the stocks.

Thus, although Mr. X was originally an amateur, he took appropriate education based on the advice from the educational site and acquired sufficient knowledge about the risks associated with the risky products. Mr. X automatically got latest information that affected the risks associated with the risky products and was able to make accurate judgments on purchasing or selling of the risky products.

Because of the presence of the educational site, an obstacle that was hindering the entry of Mr. X to switch from the safer products to the risky products was cleared.

The present invention is not limited to the embodiment explained above, but can modified in various manners as explained below.

The education system is not limited to offering the education relating to risky products possessed by the customer. It may be modified to offer education relating to risky products the customer is planning to purchase in the future. This scheme enables the customer to purchase the risky product with confidence.

The risky products are not limited to the financial products such as stocks and bonds, but may even include other products such as real estate or even various services.

The education system is not limited to selecting customers who possess the risky product affected by a life event or a social event. It may be modified to directly select customers who are affected by a life event or a social event. For example, customers who are expected to get promotion or who are planning to change the job may be directly selected. If the customers are selected in this manner, among the financial products that are possessed by the customer, the financial products that are affected by the events are retrieved and education on those risky products is offered to the customers. Alternatively, educations corresponding to the events are given to the customers on all the risky products possessed by them.

The education system is not merely giving a discount if the customers pass the test. It may be modified to give the discount only if the customers have acquired test results higher than a certain limit. For instance, 10% discount may be given to the customers who acquire 100% marks and 9% discount may be given to the customers who acquire 90% marks in the test. Because the customer gets more discounts if he/she acquires higher marks, this motivates the customer to study the product harder to acquire higher marks, and consequently makes the customer more knowledgeable.

The education system is not limited to give a discount on fees. It may be modified to give the benefits in the form of coupons or points. The points may be written on or stored in a loyalty card, for example, so that a discount equivalent to the points accumulated can be obtained at some other time.

Moreover, the education server 10 and the financial institution terminal device 30 may be a single unit instead of having them separately. This allows cost reduction. However, it is preferable that the education server 10 and the financial institution terminal device 30 are separate units if the education server 10 covers products of two or more financial institutions or when the public utility or the neutrality of the education server 10 as an education system is of importance.

Furthermore, the structures and functions of the apparatuses, devices, and the units shown in the drawings are exemplary. In other words, a part of the structure of and the function performed by a unit may be allocated to other unit.

Furthermore, some or all of the automatic processes explained above may even be carried out manually, and vice versa. The sequence of processes, the sequence of controls, specific names, and data including various parameters may be changed as required unless and until the results are the same.

The processes or methods explained above can be realized by executing computer programs pre-installed in a computer system such as a PC or a workstation.

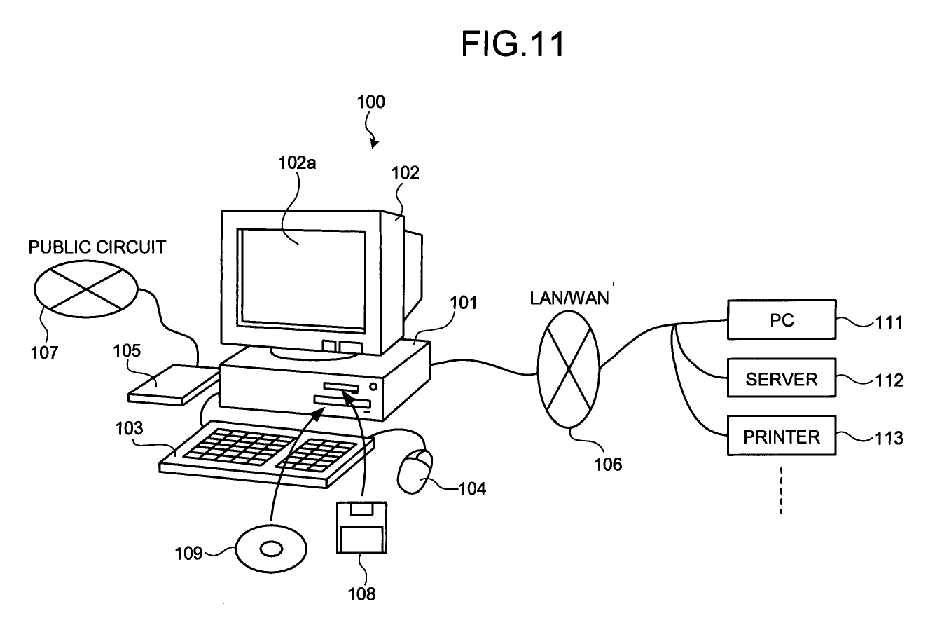

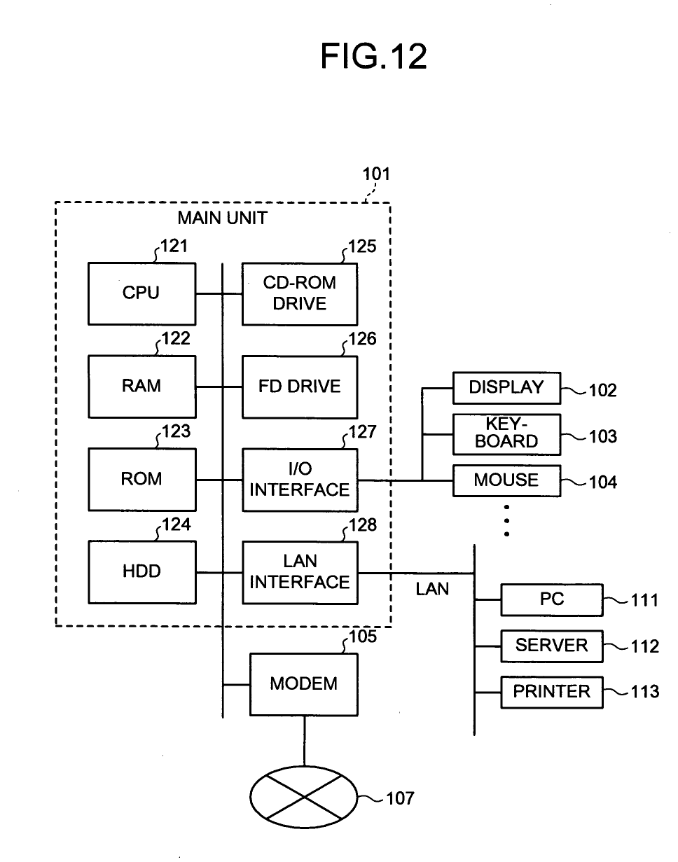

FIG. 11 is a schematic of a computer system that makes it possible to realize the apparatus and the steps in the method according to the present invention on a computer. FIG. 12 is a block diagram of a main unit of the computer system. A computer system 100 includes a main unit 101, a display 102 that includes a display screen 102a to display different tables mentioned above, a keyboard 103 for inputting data, and a mouse 104 for pointing an item on the display screen 102a.

The main unit 101 includes a central processing unit (CPU) 121, a random-access-memory (RAM) 122, a read-only-memory (ROM) 123, a hard disk drive (HDD) 124, a compact disk-read only memory (CD-ROM) drive 125 that can read data from or write data on a CD-ROM 109, a flexible disk (FD) drive 126 that can read data from or write data on an FD 108, an input/output (I/O) interface 127 to which the display 102, the keyboard 103, and the mouse 104 are connected, and a local area network (LAN) interface 128 that is connected to a local area network/wide area network (LAN/WAN) 106.

The computer system 100 is connected to a public circuit 107 such as the Internet via a modem 105. Another computer system (PC) 111, a server 112, and a printer 113 are connected to the computer system 100 via the LAN interface 128 and the LAN/WAN 106.

The computer system 100 realizes the functions of the education server 10 and the vendor server 30 by reading and executing the computer programs recorded in a recording medium. The recording medium may be a portable medium such as the FD 108, the CD-ROM 109, a magneto-optical (MO) disk, a digital versatile disk (DVD), and an IC card. The recording medium may be a fixed medium such as the HDD 124 that is one of internal and external drives, the RAM 122, and the ROM 123. On the other hand, the computer programs may be downloaded temporarily from other computers via the public circuit 107 or from the computer system 111 or the server 112 via the LAN/WAN 106.

Thus, the present invention provides a means and a method that allows providing, via a network, a customer with information on the risks associated with the risky products. This facilitates understanding of the customers about the risks associated with the risky products as well as clears the obstacle that is hindering the entry of the customers who are deliberating to switch from the safer products to the risky products enabling sound expansion and growth of market of the risky products.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An apparatus for providing, via a network, a customer device of a customer with information on risks associated with a risky product, comprising:
an education giving unit that gives an education related to the risks to the customer through the customer device; and
an education history storing unit that stores a progress of the education given to the customer as a history of the education given.

2. The apparatus according to claim 1, wherein the education giving unit gives the customer the education related to the risks associated with the risky product the customer is planning to purchase.

3. The apparatus according to claim 1, wherein the education giving unit gives the customer the education related to the risks associated with the risky product the customer has purchased.

4. The apparatus according to claim 1, wherein the education giving unit monitors whether a life event occurs, and the education giving unit gives the education to a customer who is affected by the life event if the life event occurs.

5. The apparatus according to claim 1, wherein the education giving unit monitors whether a social event occurs, and the education giving unit gives the education to a customer who is affected by the social event if the social event occurs.

6. The apparatus according to claim 1, wherein the education giving unit gives the customer the education related to the risks associated with the risky product according to the history stored.

7. The apparatus according to claim 1, wherein
the education giving unit conducts a test to check how much the customer has understood about the risks, and
the education history storing unit stores a result of the test as the history.

8. The apparatus according to claim 7, further comprising a benefit offering unit that offers the customer a discount on at least one of a purchase commission fee and an administration commission fee according to the result of the test.

9. The apparatus according to claim 7, further comprising a purchase restricting unit that restricts purchase of the risky product by the customer according to the result of the test.

10. The apparatus according to claim 7, wherein the risky product is any of stocks and bonds handled by financial institutions.

11. A method of providing, via a network, a customer device of a customer with information on risks associated with a risky product, comprising:
giving an education related to the risks to the customer through the customer device; and
storing a progress of the education given to the customer as a history of the education given.

12. The method according to claim 11, wherein the giving includes giving the customer the education related to the risks associated with the risky product the customer is planning to purchase.

13. The method according to claim 11, wherein the giving includes giving the customer the education related to the risks associated with the risky product the customer has purchased.

14. The method according to claim 11, wherein the giving includes
monitoring whether a life event occurs; and
giving the education to a customer who is affected by the life event if the life event occurs.

15. The method according to claim 11, wherein the giving includes
monitoring whether a social event occurs; and
giving the education to a customer who is affected by the social event if the social event occurs.

16. The method according to claim 11, wherein the giving includes giving the customer the education related to the risks associated to the risky product according to the history stored.

17. The method according to claim 11, wherein
giving includes conducting a test to check how much the customer has understood about the risks, and
the storing includes storing a result of the test as the history.

18. The method according to claim 17, further comprising offering the customer a discount on at least one of a purchase commission fee and an administration commission fee according to the result of the test.

19. The method according to claim 17, further comprising restricting purchase of the risky product by the customer according to the result of the test.

20. A computer program for providing, via a network, a customer device of a customer with information on risks associated with a risky product, making a computer execute:
giving an education related to the risks to the customer through the customer device; and
storing a progress of the education given to the customer as a history of the education given.
